(19) United States
(12) Patent Application Publication
(10) Pub. No.: US 2026/0128546 A1
(43) Pub. Date: May 7, 2026

(54) ELECTRICAL CONNECTORS FOR SPLICING CONNECTIONS

(71) Applicant: IDEAL Industries, Inc., Sycamore, IL (US)

(72) Inventors: Alan E. Zantout, Sycamore, IL (US); Jason W. Ludewig, Rockford, IL (US)

(21) Appl. No.: 19/381,134

(22) Filed: Nov. 6, 2025

Related U.S. Application Data
(60) Provisional application No. 63/717,593, filed on Nov. 7, 2024.

(51) Int. Cl. H01R 13/428; H01R 4/48

(52) U.S. Cl. CPC H01R 13/428; H01R 4/48455; H01R 4/4846

(57) ABSTRACT

An electrical connector includes a housing defining a first port, a second port substantially parallel to the first port, and a third port substantially perpendicular to the first and second ports. The electrical connector includes a busbar positioned within the housing and facilitating electrical contact between the plurality of electrical conductors. The electrical connector includes a plurality of clamping connections that, when engaged, each holds at least one of the plurality of electrical conductors received in at least one of the plurality of ports in electrical connection with the busbar.

### CROSS-REFERENCE TO RELATED APPLICATION

This application claims the benefit of priority to U.S. application Ser. No. 63/717,593, filed on Nov. 7, 2025, which is hereby incorporated by reference in its entirety.

### FIELD OF THE DISCLOSURE

The present disclosure generally relates to electrical connectors, such as lever and push-in connectors.

### BACKGROUND

Manual splicing of electrical conductors, such as wires or cables, can be a time-consuming and labor-intensive process, requiring careful attention to detail to establish a safe and reliable connection. Splicing may require careful manipulation so that the electrical conductors are properly seated and in good electrical contact with each other. This can be particularly difficult in applications where multiple electrical conductors need to be spliced, such as in junction boxes or distribution panels.

### BRIEF DESCRIPTION OF THE DRAWINGS

FIG. 1A is a perspective view of an electrical connector.

FIG. 1B is a front cross-sectional view of the electrical connector of FIG. 1A.

FIG. 1C is a side cross-sectional view of the electrical connector of FIG. 1A.

FIG. 1D is an exploded view of the electrical connector of FIG. 1A.

FIG. 2A is a perspective view of an electrical connector with electrical conductors connected to the busbar.

FIG. 2B is a front cross-sectional view of the electrical connector of FIG. 2A.

FIG. 2C is a side cross-sectional view of the electrical connector of FIG. 2A.

FIG. 2D is an exploded view of the electrical connector of FIG. 2A.

FIG. 3A is a perspective view of an electrical connector.

FIG. 3B is a perspective view of the electrical connector of FIG. 3A.

FIG. 3C is an exploded view of the electrical connector of FIG. 3A.

FIG. 4A is a perspective view of an electrical connector.

FIG. 4B is a perspective view of the electrical connector of FIG. 4A.

FIG. 4C is a bottom perspective view of an upper part of the electrical connector of FIG. 4A.

FIG. 4D is an exploded view of the upper part of the electrical connector of FIG. 4A.

FIG. 4E is a bottom perspective view of the electrical connector of FIG. 4A.

FIG. 4F is a perspective view of the electrical connector of FIG. 4A affixed to a junction box.

FIG. 4G is a perspective view of the electrical connector of FIG. 4A with an integrated base.

FIG. 4H is a perspective view of the integrated base of the electrical connector of FIG. 4A.

### DETAILED DESCRIPTION

The complexity of installing electrical splices can lead to errors, such as loose connections, overheating, or electrical shock, which can have serious consequences in terms of safety and system reliability. Manual approaches for splicing, such as twisting or soldering, may be cumbersome and require specialized tools and training, which can increase the overall cost and complexity of the wiring process. As a result, there is a need for a more simple and efficient approach for splicing electrical conductors in electrical systems. Embodiments of the present disclosure include connectors that provide a single connection point for splicing multiple electrical conductors in a fast, secure, and user-friendly manner that improves on known splicing devices and approaches. Embodiments may include mechanical attachments (e.g., push-in or lever) to the electrical conductors that provide reliable electrical connections while reducing the amount of manual manipulation of electrical conductors. Embodiments may also provide multi-directional routing of electrical conductors for improved electrical conductor organization.

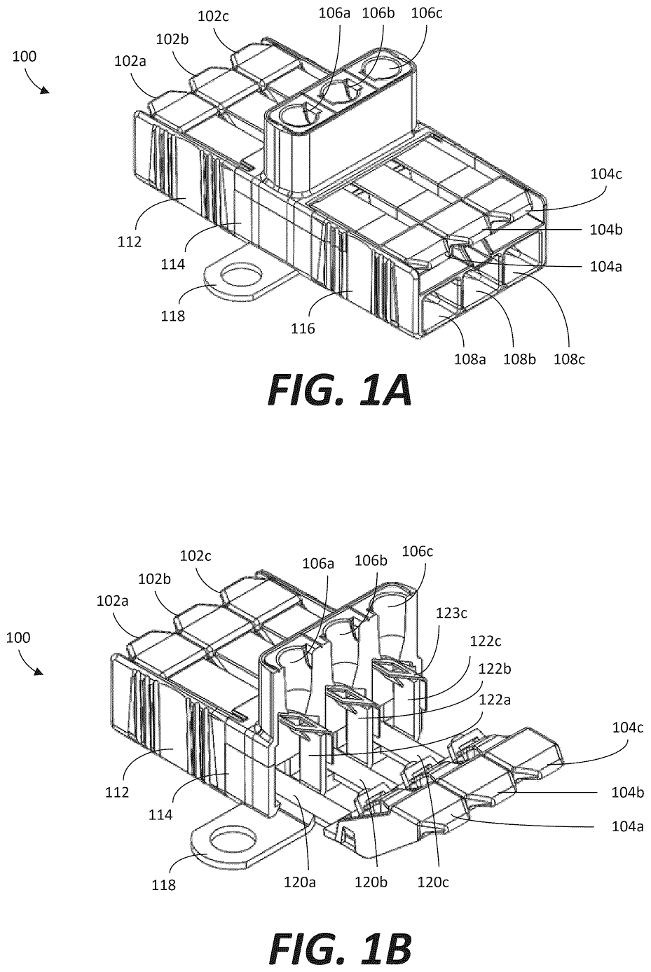

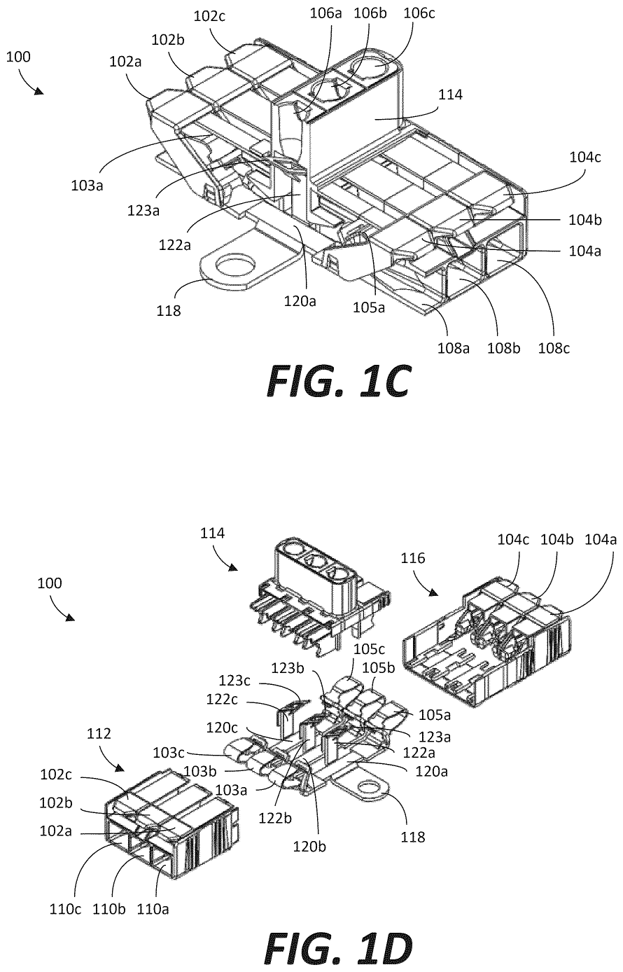

FIGS. 1A-1D illustrate a connector 100. The connector 100 may include features such as levers, resilient members or springs, entry ports, and busbar materials and features from the connectors described in U.S. Pat. No. 11,695,224, which is hereby incorporated by reference in its entirety.

The connector 100 may include a housing composed of one or more parts. For example, in the exemplary embodiment depicted in the figures (particularly FIG. 1D), the housing includes a left part 112, a center part 114, and a right part 116.

The housing (e.g., the left part 112, center part 114, and right part 116) may be made from or may comprise a rigid, electrically insulative material. For example, the housing of the connector 100 may be made from or may comprise polycarbonate, nylon, polypropylene, thermoplastic elastomer (TPE), such as thermoplastic polyurethane (TPU), and/or another appropriate material. If made from multiple parts, each part of the housing (e.g., the left part 112, center part 114, and right part 116) may include complementary mechanical features for coupling with each other, such as latches, threads, snap fits, clips, hinges, ultrasonic welding, heat stake, magnets, bayonet mounts, slots, and/or the like.

The housing of the connector 100 may define a set of ports. Each port may receive an electrical conductor and lead to a respective clamping connection for forming an electrical connection with another electrical conductor. For example, the housing may define one or more sets of three ports, each set for forming an electrical connection between three electrical conductors. As shown in FIGS. 1A-1D, the housing of the connector 100 defines three sets of three ports, each set of ports being adjacent to the next set of ports. The first set of ports includes a left port 110a, center port 106a, and right port 108a. The second set of ports includes a left port 110b, center port 106b, and right port 108b. The third set of ports includes a left port 110c, center port 106c, and right port 108c. It should be understood, however, that the housing may define more or less than three sets of ports, and each set may include more or less than three ports.

A set of ports may be configured to splice an electrical connection in multiple directions. For example, as shown in FIGS. 1A-1D, the left port 110a may be substantially opposed to the right port 108a (e.g., the insertion direction for a conductor to be inserted into the left port 110a may be substantially opposed to the insertion direction for a conductor to be inserted into the right port 108a). That is, the left port 110a and right port 108a (in terms of the respective conductor insertion directions defined by the left port 110a and right port 108a) may lay on the same axis and/or plane, or otherwise in parallel axes or planes. Additionally, the center port 106a may be substantially perpendicular (e.g., again in terms of the conductor insertion direction defined by the port 106a) to the left port 110a and right port 108a. That is, the center port 106a may lay on a different axis and/or plane that intersects (e.g., in the housing) with the axis and/or plane of the left port 110a and/or right port 108a.

Each other set of ports on the same connector 100 may be configured to splice an electrical connection in the same and/or different directions. For example, the second and third sets of ports on connector 100 are in the same directional configuration as the first set of ports (left port 110a, center port 106a, and right port 108a). That is, left ports 110b, 110c may be substantially opposed to the right ports 108b, 108c, respectively, and center ports 106b, 106c may be substantially perpendicular to the left port 110b and right port 108b and the left port 110c and right port 108c, respectively.

The connector 100 may also include one or more busbars 120. Each busbar 120 may serve as a common electrical junction, facilitating the connection between multiple electrical conductors. Accordingly, each set of ports may have its own busbar. For example, the first set of ports (left port 110a, center port 106a, and right port 108a) may include a busbar 120a, the second set of ports (left port 110b, center port 106b, and right port 108b) may include a busbar 120b, and the third set of ports (left port 110c, center port 106c, and right port 108c) may include a busbar 120c.

Each busbar 120 may be a solid, flat, or curved piece of conductive material, such as copper or a copper alloy, which may be designed to provide a low-resistance path for the flow of electrical current between electrical conductors inserted in the ports of a set of ports. Each busbar 120 may be positioned within the connector 100 (e.g., the housing of the connector) in a way that allows the busbar 120 to make physical contact with each of the electrical conductors that are inserted into the ports 110, 106, 108, thereby facilitating a secure and reliable electrical connection between the electrical conductors.

Each busbar 120 in the connector 100 may make a physical connection with an electrical conductor through a mechanical or pressure-based connection rather than a soldered or welded joint. Each busbar 120 may extend into the ports 110, 106, 108 of the connector 100. This can be achieved through a variety of techniques, such as a stamped or machined extension of the busbar 120 that forms a contact surface or terminal that extends into the port. When the electrical conductor is inserted into the port, the electrical conductor may contact the extended busbar 120, facilitating an electrical connection.

To secure the electrical connection between an electrical conductor and the busbar 120, the port (e.g., ports 110, 108) may include an attachment mechanism that, when actuated, engages the attachment mechanism. For example, the attachment mechanism may include a clamping connection, such as a lever connection, push-in connection, or an insulation displacement or piercing connection. When the clamping connection is engaged, the electrical conductor received in the corresponding port may be held in electrical connection (e.g., physical contact) with the busbar 120. The attachment mechanism may include a lever 102, 104 or other pivoting or hinged component that is mounted to the port and is designed to apply pressure to the electrical conductor when inserted into the port. Each lever 102, 104 may correspond to a spring 103, 105, respectively. Each spring 103, 105 may be biased towards a closed position. When a lever 102, 104 is moved into an open position, it may apply an opening force, opposite the spring bias, to open a clamping connection comprising the spring 103, 105. When the lever 102, 104 is moved into a closed position, the opening force of the lever 102, 104 may be released and the spring 103, 105 may close the clamping connection to clamp the electrical conductor between spring 103, 105 and the busbar 120. Accordingly, each spring 103, 105 and the busbar 120 may define a respective clamping connection accessible from a respective port along a conductor insertion direction defined by the port that extends from the port to the clamping connection.

For example, when the electrical conductor is pushed into port 108, the lever 104 may be initially in an open position, with the lever 104 applying force to the spring 105 to open the clamping connection and permit the electrical conductor to be inserted. After the electrical conductor is fully inserted, the lever 104 may be pivoted or hinged (e.g., by a user) into a closed position, permitting a clamping force to be applied to the electrical conductor by the spring 105.

In some embodiments, the lever 102, 104 may be self-locking, meaning that it may remain in the closed position until it is opened, providing a secure and reliable connection. This can be achieved through the use of a detent or a latch, for example, that holds the lever 102, 104 in place, or through the use of a spring or other biasing mechanism that keeps the lever 102, 104 closed. The levers 102, 104 may also or instead be designed to provide a clear visual indication of when the clamp is open or closed, such as through the use of a color-coded indicator or a tactile feedback mechanism.

To secure the electrical connection between an electrical conductor and the busbar 120, the port 106 may include an attachment mechanism that engages when an electrical conductor is inserted. For example, the attachment mechanism may be a push-in connection. When an electrical conductor is inserted into the push-in connection, the insertion may cause a spring 123 of the push-in connection to deflect and accept the electrical conductor, and then apply pressure on a metal contact (e.g., busbar arm 122) and the electrical conductor. The spring 123 may be a separate component attached to the arm 122 or integrated with the arm 122. In some embodiments, the attachment mechanism may be an insulation displacement connection or insulation piercing connection, if the electrical conductor has an insulation.

The port may have a tapered or chamfered entrance that guides the conductor into place at a clamping connection. The electrical conductor may have an exposed end that protrudes from an insulation, which may be inserted into the port and come into electrical contact with the busbar 120 when inserted into the port. In some embodiments, the port may be an insulation displacement connection. An arm 122 of the busbar 120 may include a contact that, when the connection is engaged, causes the contact to cut or push into an insulator or sheath of the electrical conductor so as to come into electrical contact with the electrical conductor.

In some embodiments, one or more busbars 120 of the connector 100 may include a grounding arm 118. The grounding arm 118 may be a protruding component of the busbar 120 that extends from the housing and provides a means of connecting the busbar 120 to a grounding point. The grounding arm 118 may be a rigid or semi-rigid component that provides a stable and secure connection to the grounding point. The grounding arm 118 may be designed to be attached (e.g., screwed) to the grounding point using a fastener (e.g., a screw or bolt). The fastener may be inserted through a hole or slot in the grounding arm 118 and may then be tightened to secure the grounding arm 118 to the grounding point. The grounding arm 118 may be fabricated from the same material as its corresponding busbar 120 or may be a separate material (e.g., copper, copper alloy, or other conductive material) attached to its corresponding busbar 120.

Although the connector 100 is illustrated with three sets of ports, any number of sets may be included. In addition, although the connector is illustrated as a three-way splice, any number of ports per connection may be provided. For example, in an embodiment, a connector may be a four-way splice, with two center parts 114 adjacent to and aligned with each other. Furthermore, the attachment mechanism may be the same or different across each port in a set of ports. For example, rather than two lever attachment mechanisms and a push-in attachment mechanism as shown in FIGS. 1A-1D, each port may include lever attachment mechanisms, or each port may include push-in attachment mechanisms, etc.

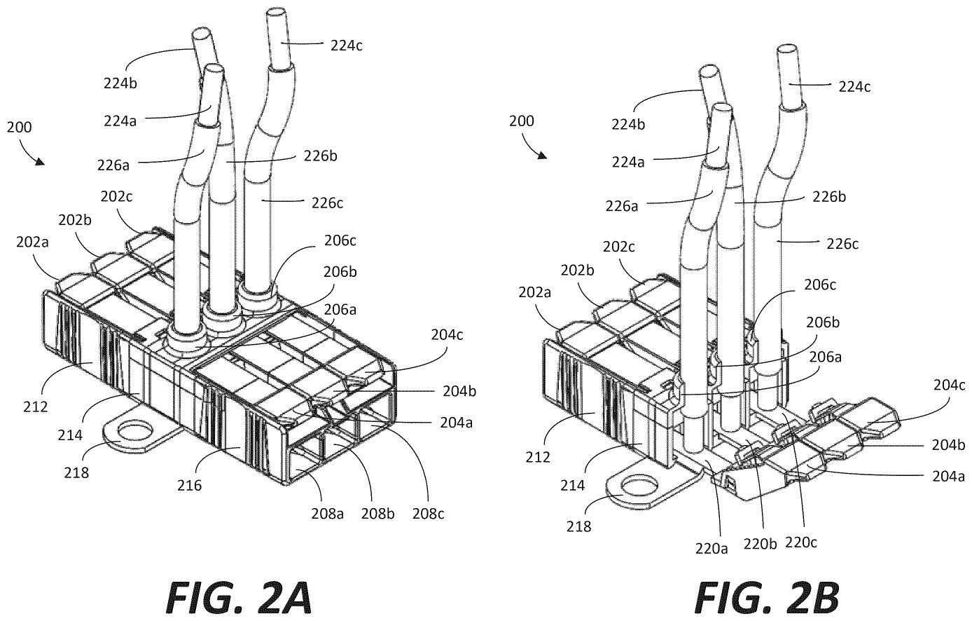

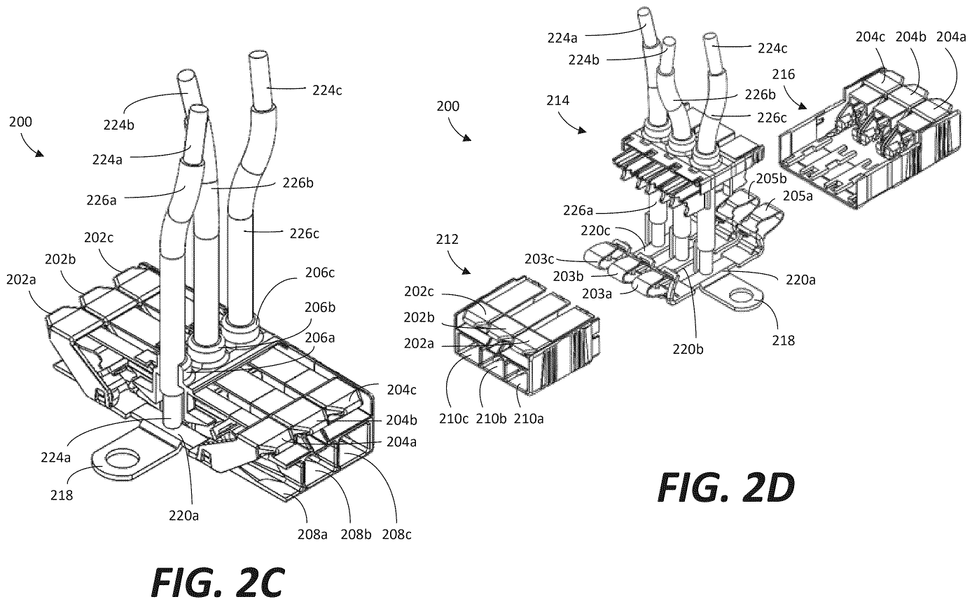

FIGS. 2A-2D illustrate an electrical connector 200 with electrical conductors 224 connected to the busbar 220. The electrical connector 200 may be substantially identical to the electrical connector 100 but may instead include electrical conductors pre-connected (e.g., pre-integrated with or pre-attached to) the busbar 220. Components of the electrical connector 200 that are similar to the components of the electrical connector 100 have similar characteristics and thus their descriptions will not be repeated. For example, the ports 208, 210 are similar to the ports 108, 110.

The busbar 220 with an integrated electrical conductor 224 may be a type of busbar 220 that has an electrical conductor (e.g., wire or cable) that is attached (e.g., permanently) to the busbar 220, allowing for easy splicing of connections with other wires or devices like a wall outlet. The integrated electrical conductor 224 may be a flexible or semi-rigid cable that is attached to the busbar 220 through a secure and reliable connection, such as a solder joint, welding, crimping, or is fabricated from the same material as the busbar 220. The integrated electrical conductor 224 may be made of a conductive material, such as copper or a copper alloy, and may be designed to provide a low-resistance path for the flow of electrical current.

The integrated electrical conductor 224 may be designed to be long enough to allow for easy splicing with other wires and may be provided with a stripped or tinned end to facilitate connections beyond the housing of the connector 200. The integrated electrical conductor 224 may also be color-coded or labeled to indicate its function or polarity, making it easier to identify and connect to other electrical conductors.

The integrated electrical conductor 224 may be covered with an insulation 226, which may be a layer of non-conductive material that surrounds the integrated electrical conductor 224 and protects it from the environment. The insulation 226 may be made of a flexible or semi-rigid material, such as PVC, Teflon, or silicone, and may be designed to provide electrical insulation and protection. The insulation 226 may be colored or labeled to indicate the function or polarity of the integrated electrical conductor 224, making it easier to identify and connect to other electrical conductors. The insulation 226 may also help to prevent electrical shock or short circuits, by preventing the wire from coming into contact with other conductive materials.

The connector 200 may include a housing composed of one or more parts. For example, in the exemplary embodiment depicted in the figures (particularly FIG. 2D), the housing includes a left part 212, a center part 214, and a right part 216. The housing of the connector 200 may define a set of ports 208, 210. Each port 208, 210 may receive an electrical conductor and lead to a respective clamping connection for forming an electrical connection with another electrical conductor. In addition to ports 208, 210, the housing of the connector 200 may also define a set of openings 206 for exposing the integrated electrical conductor 224 while also covering the busbar 220. For example, the integrated electrical conductor 224 may be fed through a corresponding opening 206, as shown in FIGS. 2A-2D.

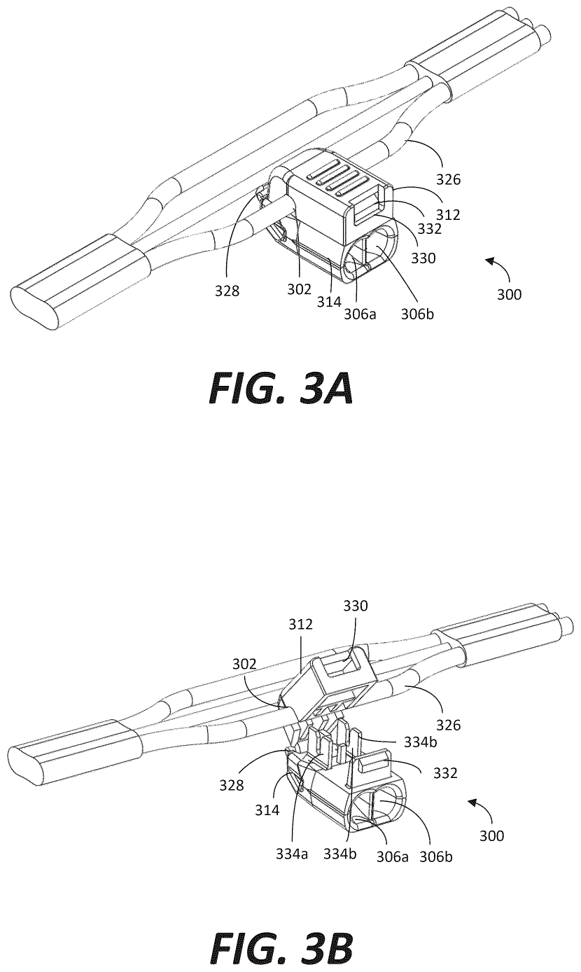

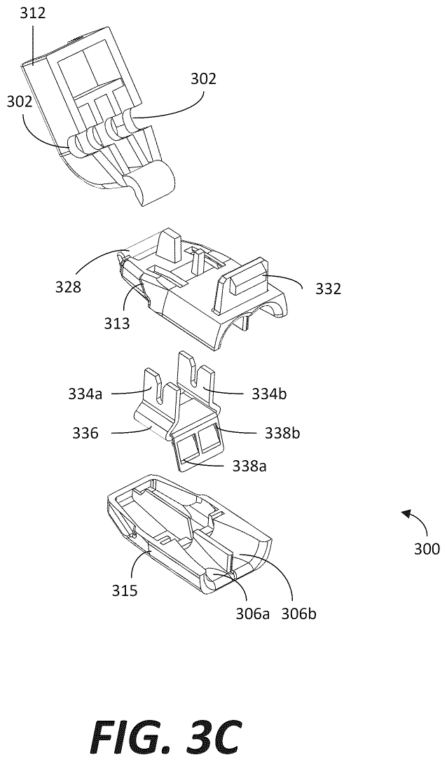

FIGS. 3A-3C illustrate an electrical connector 300. Like the electrical connectors 100, 200, the electrical connector 300 may be used for splicing electrical conductors. However, unlike the electrical connectors 100, 200, the splicing facilitated by the electrical connector 300 may allow one or more push-in, levered, or other connections to tap into an electrical conductor and the housing of the connector 300 may define the clamping connection.

The connector 300 may include a housing composed of one or more parts. For example, in the exemplary embodiments depicted in the figures (particularly FIG. 3C), the housing includes an upper part 312 and a lower part 314 (which may be formed from a first portion 313 and a second portion 315).

The housing (e.g., the upper part 312 and lower part 314) may be made from or may comprise a rigid, electrically insulative material. For example, the housing of the connector 300 may be made from or may comprise TPE, such as TPU, and/or another appropriate material. If made from multiple parts, each part of the housing (e.g., the upper part 312 and lower part 314) may include complementary mechanical features for coupling with each other, such as latches, threads, snap fits, clips, hinges, magnets, bayonet mounts, slots, and/or the like. For example, the housing of the connector 300 may include a hinge 328 and complementary mechanical connections 330, 332 for clamping the housing onto an electrical conductor 326.

The housing may define one or more ports 302, 306 for receiving a plurality of electrical conductors. At least two of the plurality of ports (e.g., ports 302) may be placed on a first plane or axis, and at least one of the plurality of ports (e.g., ports 306a, 306b) may be placed on a second plane or axis that intersects the first plane or axis within the housing of the connector 300. The ports 302 may receive a single electrical conductor 326 and thus the ports 302 may be substantially opposed from one another. The connector 300 may facilitate the splicing of one or more electrical conductors with the electrical conductor 326, each of which may be placed in port 306. For example, the connector 300 is depicted as facilitating the splicing of two electrical conductors (which may be inserted into ports 306a, 306b) with the electrical conductor 326.

The connector 300 may also include a busbar 336. The busbar 336 may serve as a common electrical junction, facilitating the connection between multiple electrical conductors. The busbar 336 may be a solid, flat, or curved piece of conductive material, such as copper or a copper alloy, which may be designed to provide a low-resistance path for the flow of electrical current. The busbar 336 may be positioned within the connector 300 (e.g., the housing of the connector 300) in a way that allows the busbar 336 to make physical contact with each of the electrical conductors that are inserted into the ports 306, thereby facilitating a secure and reliable electrical connection between the electrical conductors.

The busbar 336 in the connector 300 may make a physical connection with an electrical conductor through a push-in connection. For example, when the electrical conductor is inserted into the port 306, the insertion may cause a spring 338 (e.g., a steel spring connected to the busbar 336) corresponding to the port 306 to deflect and accept the electrical conductor, and then apply pressure on the electrical conductor so that the electrical conductor may contact the busbar 336, facilitating an electrical connection. In some embodiments, the port 306 may also or instead include a levered connection like ports 208, 210, described above, or some other type of connection.

The busbar 336 may also include (e.g., be attached to or integrated with) one or more contacts 334 or terminals extending into the upper part 312 of the housing. The contacts 334 may form an insulation displacement connection or insulation piercing connection so that the electrical conductor does not need to be stripped before use with the connector 300. For example, the contacts 334 may include one or more cutting edges that are sharpened or otherwise configured to peel, cut, pierce, or otherwise displace an insulation of an electrical conductor 326 so that each contact 334 (e.g., contacts 334a, 334b corresponding to ports 306a, 306b, respectively) may be in electrical contact with the electrical conductor 326 when the clamping connection of the connector 300 is engaged. When the clamping connection of the connector 300 is engaged, the clamping force pushes the cutting edge of the contact 334 into the electrical conductor 326, causing the contact 334 to make electrical contact with the electrical conductor 326 through an insulation of the electrical conductor 326.

For example, when the electrical conductor 326 is placed into port 302, the housing may be initially in an open position (e.g., the upper part 312 and lower part 314 of the housing being only connected at the hinge 328), allowing the electrical conductor 326 to be easily inserted. As the electrical conductor 326 is fully inserted, the housing may be pivoted or hinged (e.g., by a user) into a closed position, applying a clamping force to the electrical conductor 326. The clamping force may be applied at least in part by the contact 334 of the busbar 336, which makes contact with the electrical conductor 326.

In some embodiments, the housing may be self-locking, meaning that it may remain in the closed position until it is opened, providing a secure and reliable connection. This can be achieved through the use of a detent or a latch, for example, that holds the housing in place, or through the use of a spring or other biasing mechanism that keeps the housing closed. The housing may also or instead be designed to provide a clear visual indication of when the clamp is open or closed, such as through the use of a color-coded indicator or a tactile feedback mechanism.

In some embodiments, the busbar 336 may include integrated electrical conductors, similar to integrated electrical conductors 224 of the embodiments described with respect to FIGS. 2A-2D. The integrated electrical conductors may be fed through the port 306 or ports 302.

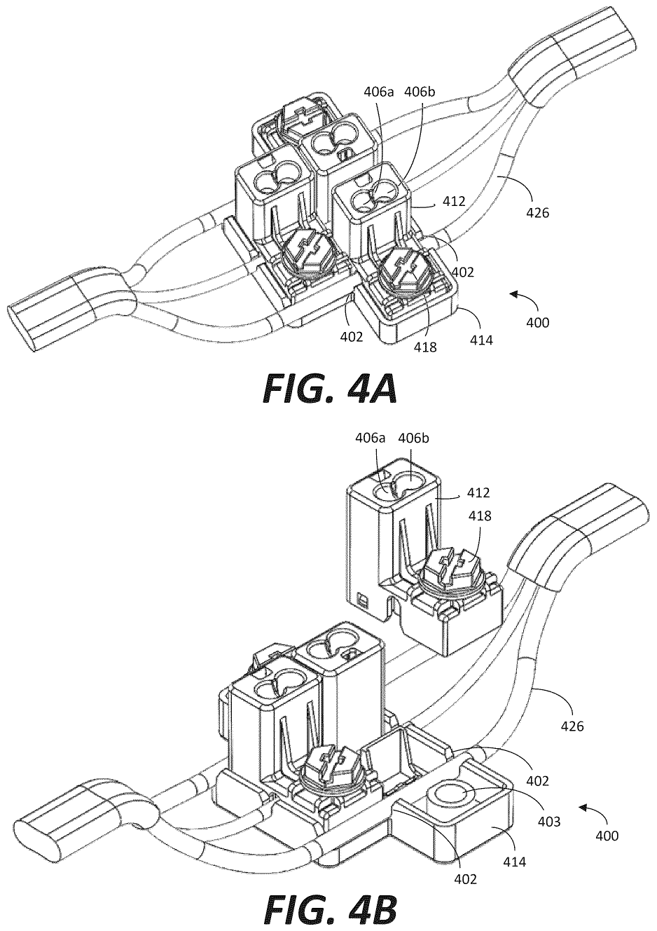

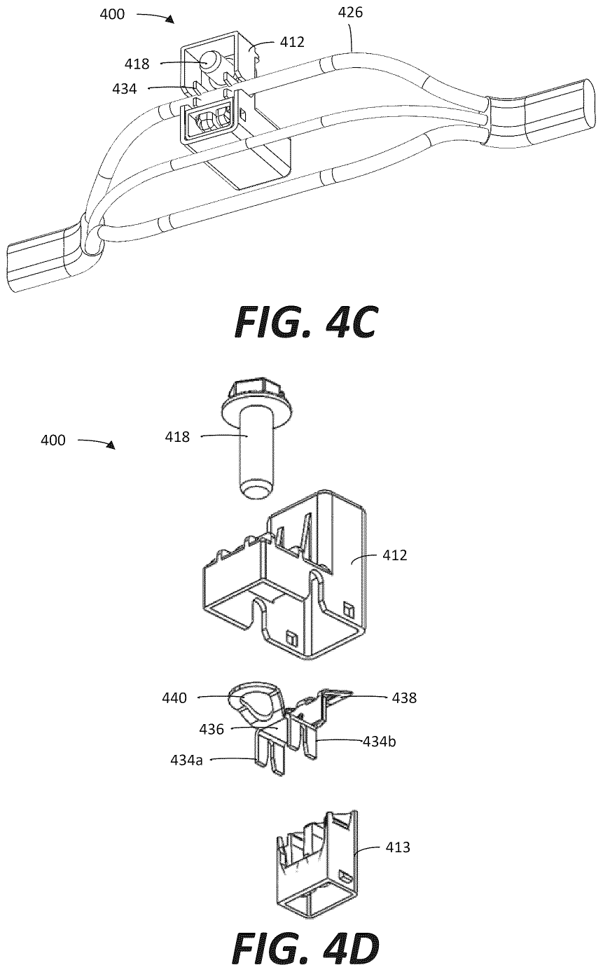

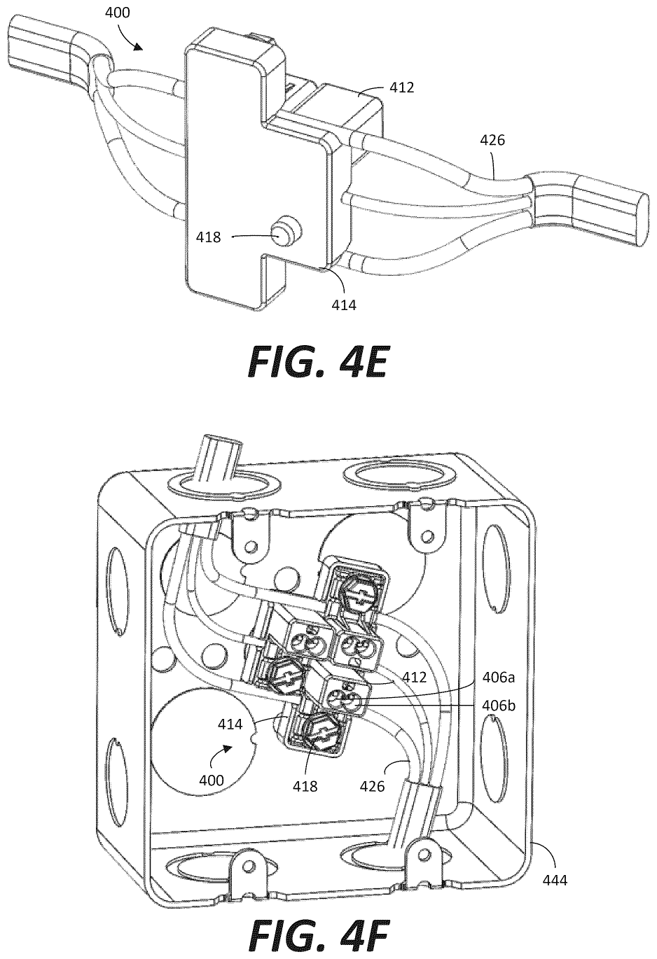

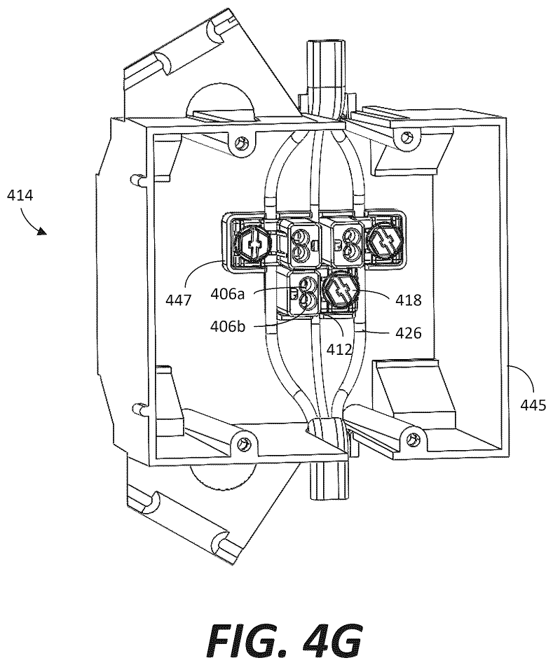

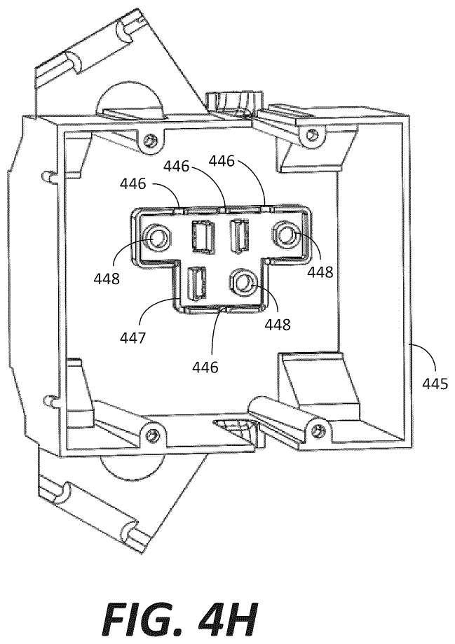

FIGS. 4A-4H illustrate a connector 400. Like the electrical connectors 100, 200, the electrical connector 400 may be used for splicing electrical conductors. However, unlike the electrical connectors 100, 200, the splicing facilitated by the electrical connector 400 may allow one or more push-in, levered, or other connections to tap into an electrical conductor and at least part of the housing of the connector 400 may be connected to or integrated with other components, such as junction boxes (as shown in FIGS. 4F-4H).

The connector 400 may include a housing composed of one or more parts. For example, in the exemplary embodiments depicted in the figures (particularly FIG. 4B), the housing may include an upper part 412 and a lower part 414. In some embodiments, the lower part 414 may be configured to receive one or more upper parts (e.g., upper part 412) or vice versa. In some embodiments, such as shown in FIGS. 4G & 4H, the lower part 414 may be an integrated junction box 445 having a raised portion 447 defining one or more ports 446 (e.g., placement guides for one or more electrical conductors) and/or one or more receptacles 448 (e.g., threaded inserts) each for receiving a fastener 418 (e.g., a screw or bolt).

The housing (e.g., the upper part 412 and lower part 414) may be made from or may comprise a rigid, electrically insulative material. For example, the housing of the connector 400 may be made from or may comprise polycarbonate, nylon, polypropylene, TPE, such as TPU, and/or another appropriate material. Each part of the housing (e.g., the upper part 412 and lower part 414) may include complementary mechanical features for coupling with each other, such as latches, threads, snap fits, clips, hinges, magnets, bayonet mounts, slots, and/or the like. For example, the upper part 412 and the lower part 414 of the housing may each include a receptacle (e.g., receptacle 403) for receiving a fastener 418 that, when fully inserted, may clamp the upper part 412 of the housing onto an electrical conductor 426 seated on the lower part 414.

In some embodiments, the busbar 436 may also include a receptacle 440 that aligns with the receptacles (e.g., receptacle 403) of the upper part 412 and the lower part 414 for receiving the fastener 418. The receptacle 440 may allow the busbar 436 to receive the fastener 418 while also facilitating electrical contact with the fastener 418. The electrical contact with the fastener 418 may allow the busbar 436 to become grounded when the fastener attaches to a surface separate from the connector 400. For example, FIG. 4E depicts the fastener 418 protruding through the lower part 414 of the housing, which may be used to attach the connector 400 to a junction box 444 or other grounding surface (e.g., as shown in FIG. 4F).

The housing may define one or more ports 402, 406 for receiving a plurality of electrical conductors. At least two of the plurality of ports (e.g., ports 402) may be placed on a first plane or axis, and at least one of the plurality of ports (e.g., ports 406a, 406b) may be placed on a second plane or axis that intersects the first plane or axis within the housing of the connector 400. The ports 402 may receive a single electrical conductor and thus the ports 402 may be substantially opposed from one another. The connector 400 may facilitate the splicing of one or more electrical conductors with the electrical conductor 426, each of which may be placed in port 406. For example, the connector 400 is depicted as facilitating the splicing of two electrical conductors (which may be inserted into ports 406a, 406b) with the electrical conductor 426.

The connector 400 may also include a busbar 436. The busbar 436 may serve as a common electrical junction, facilitating the connection between multiple electrical conductors. The busbar 436 may be a solid, flat, or curved piece of conductive material, such as copper or a copper alloy, which may be designed to provide a low-resistance path for the flow of electrical current. The busbar 436 may be positioned within the connector 400 (e.g., the upper part 412 of the housing of the connector 400) in a way that allows the busbar 436 to make physical contact with each of the electrical conductors that are inserted into the ports 406, thereby facilitating a secure and reliable electrical connection between the electrical conductors.

The busbar 436 in the connector 400 may make a physical connection with an electrical conductor through a push-in connection. When the electrical conductor is inserted into the port 406, the insertion may cause a spring (e.g., inside part 413) to deflect and accept the electrical conductor, and then apply pressure on the electrical conductor so that the electrical conductor may contact the busbar 436, facilitating an electrical connection. In some embodiments, the port 406 may also or instead include a levered connection like ports 208, 210, described above, or other type of connection.

The busbar 436 may also include (e.g., be attached to or integrated with) one or more contacts 434 or terminals that extend into the lower part 414 of the housing. The contacts 434 may form an insulation displacement connection or insulation piercing connection so that the electrical conductor does not need to be stripped before use with the connector 400. For example, the contacts 434 may include one or more cutting edges that are sharpened or otherwise configured to peel, cut, pierce, or otherwise displace an insulation of an electrical conductor 426 so that each contact 434 may be in electrical contact with the electrical conductor 426 when the clamping connection of the connector 400 is engaged (e.g., fastener 418 is tightened). When the clamping connection of the connector 400 is engaged, the clamping force pushes the cutting edge of the contact 434 into the electrical conductor 426, causing the contact 434 to make electrical contact with the electrical conductor 426 through an insulation of the electrical conductor 426. In some embodiments, the electrical conductor 426 does not include an insulation.

For example, when the electrical conductor 426 is placed into ports 402, the housing may be initially in an open position (e.g., the upper part 412 separated from the lower part 414), allowing the electrical conductor 426 to be easily inserted. However, as the electrical conductor 426 is fully seated (e.g., on the lower part 414), the upper part 412 housing may be attached (e.g., by a user) to the lower part 414 (e.g., by tightening a fastener 418), applying a clamping force to the electrical conductor 426. The clamping force may be applied at least in part by the contact 434 of the busbar 436, which makes contact with the electrical conductor 426.

In some embodiments, the busbar 436 may include integrated electrical conductors, similar to integrated electrical conductors 224 of the embodiments described with respect to FIGS. 2A-2D. The integrated electrical conductors may be connected to the busbar 436 and be fed through the port 406 or ports 402.

In a first aspect of the present disclosure, an electrical connector is provided that includes a housing defining a plurality of ports for inserting a plurality of electrical conductors, wherein the plurality of ports includes a first port, a second port substantially opposed to the first port, and a third port substantially perpendicular to the first and second ports, a busbar positioned within the housing facilitating electrical contact between the plurality of electrical conductors, and a plurality of clamping connections that, when engaged, each holds at least one of the plurality of electrical conductors received in at least one of the plurality of ports in electrical connection with the busbar.

In an embodiment of the first aspect, the busbar extends into any one or more of the first, second, and third ports.

In an embodiment of the first aspect, the busbar includes a grounding arm extending beyond the housing.

In an embodiment of the first aspect, wherein the busbar includes an electrical conductor that is fed through at least one of the plurality of ports. In a further embodiment of the first aspect, the electrical conductor of the busbar that extends beyond the housing includes an insulator.

In an embodiment of the first aspect, the plurality of clamping connections includes an insulation displacement connection that, when engaged, pushes a contact of the busbar into the electrical conductor, causing the contact to make electrical contact with the electrical conductor through an insulation of the electrical conductor.

In an embodiment of the first aspect, a port of the plurality of ports is a push-in connection that, when the electrical conductor is pushed into the port, uses a spring to hold the electrical conductor to the busbar.

In an embodiment of the first aspect, a clamping connection of the plurality of clamping connections includes a lever that, when actuated by a user, engages the clamping connection.

In a second aspect of the present disclosure, an electrical connector is provided that includes a housing defining a plurality of ports for receiving a plurality of electrical conductors, wherein at least two of the plurality of ports are on a first plane, at least one of the plurality of ports are on a second plane, and the first plane and the second plane intersect within the housing, a busbar positioned within the housing facilitating electrical contact between the plurality of electrical conductors, and one or more clamping connections that, when engaged, each holds at least one of the plurality of electrical conductors received in at least one of the plurality of ports in electrical connection with the busbar, wherein the housing defines a clamping connection of the one or more clamping connections.

In an embodiment of the second aspect, the busbar includes a cutting edge configured to receive at least some of the electrical conductor such that, when the clamping connection is engaged, the clamping connection pushes the electrical conductor into the cutting edge, causing the cutting edge to make electrical contact with the electrical conductor through an insulation of the electrical conductor. In a further embodiment of the second aspect, the electrical conductor is placed on the first plane when the electrical conductor is coupled with the electrical connector, and the busbar is placed on the second plane.

In an embodiment of the second aspect, a port of the plurality of ports is a push-in connection that, when the electrical conductor is pushed into the port, uses a spring to hold the electrical conductor to the busbar. In a further embodiment of the second aspect, the electrical conductor and the busbar are placed on the first plane.

In an embodiment of the second aspect, the housing comprises a first portion and a second portion, the first portion of the housing includes one or more electrical conductor placement guides, and the second portion of the housing includes the busbar. In a further embodiment of the second aspect, the first portion is integrated with a junction box. In a further embodiment of the second aspect, the second portion includes a fastener that attaches the second portion to the first portion and provides a grounding connection to the busbar through the second portion.

In a third aspect of the present disclosure, an electrical connector is provided that includes a housing defining a plurality of ports for inserting a plurality of electrical conductors, wherein at least two of the plurality of ports are on a first plane, at least one of the plurality of ports are on a second plane, and the first plane and the second plane intersect within the housing, a busbar positioned within the housing, wherein the busbar includes a plurality of contact surfaces, and each one of the plurality of contact surfaces is associated with one of the plurality of ports, and one or more clamping connections that, when engaged, each holds at least one of the plurality of electrical conductors received in at least one of the plurality of ports against at least one of the plurality of contact surfaces associated with the at least one of the plurality of ports.

In an embodiment of the third aspect, the busbar extends into any one or more of the first, second, and third ports.

In an embodiment of the third aspect, the busbar includes a grounding arm extending beyond the housing.

In an embodiment of the third aspect, the plurality of clamping connections includes an insulation displacement connection that, when engaged, pushes a contact of the busbar into the electrical conductor, causing the contact to make electrical contact with the electrical conductor through an insulation of the electrical conductor.

While this disclosure has described certain embodiments, it will be understood that the claims are not intended to be limited to these embodiments except as explicitly recited in the claims. On the contrary, the instant disclosure is intended to cover alternatives, modifications, and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known components have not been described in detail so as not to unnecessarily obscure various aspects of the present disclosure.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

1. An electrical connector comprising:
a housing defining a plurality of ports for inserting a plurality of electrical conductors, wherein the plurality of ports includes a first port, a second port substantially opposed to the first port, and a third port substantially perpendicular to the first and second ports;
a busbar positioned within the housing facilitating electrical contact between the plurality of electrical conductors; and
a plurality of clamping connections that, when engaged, each holds at least one of the plurality of electrical conductors received in at least one of the plurality of ports in electrical connection with the busbar.

2. The electrical connector of claim 1, wherein the busbar extends into any one or more of the first, second, and third ports.

3. The electrical connector of claim 1, wherein the busbar includes a grounding arm extending beyond the housing.

4. The electrical connector of claim 1, wherein the busbar includes an electrical conductor that is fed through at least one of the plurality of ports.

5. The electrical connector of claim 4, wherein the electrical conductor of the busbar that extends beyond the housing includes an insulator.

6. The electrical connector of claim 1, wherein the plurality of clamping connections includes an insulation displacement connection that, when engaged, pushes a contact of the busbar into the electrical conductor, causing the contact to make electrical contact with the electrical conductor through an insulation of the electrical conductor.

7. The electrical connector of claim 1, wherein a port of the plurality of ports is a push-in connection that, when the electrical conductor is pushed into the port, uses a spring to hold the electrical conductor to the busbar.

8. The electrical connector of claim 1, wherein a clamping connection of the plurality of clamping connections includes a lever that, when actuated by a user, engages the clamping connection.

9. An electrical connector comprising:
a housing defining a plurality of ports for receiving a plurality of electrical conductors, wherein at least two of the plurality of ports are on a first plane, at least one of the plurality of ports are on a second plane, and the first plane and the second plane intersect within the housing;
a busbar positioned within the housing facilitating electrical contact between the plurality of electrical conductors; and
one or more clamping connections that, when engaged, each holds at least one of the plurality of electrical conductors received in at least one of the plurality of ports in electrical connection with the busbar, wherein the housing defines a clamping connection of the one or more clamping connections.

10. The electrical connector of claim 9, wherein the busbar includes a cutting edge configured to receive at least some of the electrical conductor such that, when the clamping connection is engaged, the clamping connection pushes the electrical conductor into the cutting edge, causing the cutting edge to make electrical contact with the electrical conductor through an insulation of the electrical conductor.

11. The electrical connector of claim 10, wherein the electrical conductor is placed on the first plane when the electrical conductor is coupled with the electrical connector, and the busbar is placed on the second plane.

12. The electrical connector of claim 9, wherein a port of the plurality of ports is a push-in connection that, when the electrical conductor is pushed into the port, uses a spring to hold the electrical conductor to the busbar.

13. The electrical connector of claim 12, wherein the electrical conductor and the busbar are placed on the first plane.

14. The electrical connector of claim 9, wherein:
the housing comprises a first portion and a second portion;
the first portion of the housing includes one or more electrical conductor placement guides; and
the second portion of the housing includes the busbar.

15. The electrical connector of claim 14, wherein the first portion is integrated with a junction box.

16. The electrical connector of claim 14, wherein the second portion includes a fastener that attaches the second portion to the first portion and provides a grounding connection to the busbar through the second portion.

17. An electrical connector comprising:
a housing defining a plurality of ports for inserting a plurality of electrical conductors, wherein at least two of the plurality of ports are on a first plane, at least one of the plurality of ports are on a second plane, and the first plane and the second plane intersect within the housing;
a busbar positioned within the housing, wherein the busbar includes a plurality of contact surfaces, and each one of the plurality of contact surfaces is associated with one of the plurality of ports; and
one or more clamping connections that, when engaged, each holds at least one of the plurality of electrical conductors received in at least one of the plurality of ports against at least one of the plurality of contact surfaces associated with the at least one of the plurality of ports.

18. The electrical connector of claim 17, wherein the busbar extends into any one or more of the first, second, and third ports.

19. The electrical connector of claim 17, wherein the busbar includes a grounding arm extending beyond the housing.

20. The electrical connector of claim 17, wherein the plurality of clamping connections includes an insulation displacement connection that, when engaged, pushes a contact of the busbar into the electrical conductor, causing the contact to make electrical contact with the electrical conductor through an insulation of the electrical conductor.
